(19) United States
(12) Patent Application Publication
(10) Pub. No.: US 2007/0113006 A1
(43) Pub. Date: May 17, 2007

(54) Apparatus and method to configure one or more storage arrays

(76) Inventors: John C. Elliott, Tucson, AZ (US); Shah Mohammad Rezaul Islam, Tucson, AZ (US); Robert A. Kubo, Tucson, AZ (US); Gregg S. Lucas, Tucson, AZ (US)

Correspondence Address: DALE F. REGELMAN, 4231 S. FREMONT AVENUE, TUCSON, AZ, 85714, US

(21) Appl. No.: 11/281,308

(22) Filed: Nov. 16, 2005

(51) Int. Cl. G06F 12/16; G06F 12/00

(52) U.S. Cl. 711/114; 711/170

(57) ABSTRACT

A method is disclosed to configure one or more storage arrays. The method supplies a data storage and retrieval system comprising (N) data storage device assemblies, wherein each of said (N) data storage device assemblies comprises (M) data storage devices, wherein (N) is greater than or equal to 2, and wherein (M) is greater than or equal to 2. The method configures a first storage array to comprise the (i)th data storage device disposed in two or more of said (N) data storage device assemblies, wherein (i) is greater than or equal to 1 and less than or equal to (M).

### FIELD OF THE INVENTION

This invention relates to an apparatus and method to configure one or more storage arrays in a data storage and retrieval system.

### BACKGROUND OF THE INVENTION

Data storage and retrieval systems are used to store information provided by one or more host computer systems. Such data storage and retrieval systems receive requests to write information to a plurality of data storage devices, and requests to retrieve information from that plurality of data storage devices. Upon receipt of a read request, the system recalls information from the plurality of data storage devices, and optionally moves that information to a data cache. Thus, the system is continuously moving information to and from a plurality of data storage devices, and optionally to and from a data cache.

It is known in the art to configure the plurality of data storage devices to form a storage array. It is further known to write information to such a storage array using a number of RAID protocols.

What is needed is a method to configure one or more storage arrays in a data storage array comprising a plurality of data storage device assemblies, wherein each of those data storage device assemblies comprises a plurality of data storage devices.

### SUMMARY OF THE INVENTION

Applicants' invention comprises a method to configure one or more storage arrays. Applicants' method supplies a data storage and retrieval system comprising (N) data storage device assemblies, wherein each of said (N) data storage device assemblies comprises (M) data storage devices, wherein (N) is greater than or equal to 2, and wherein (M) is greater than or equal to 2. The method configures a first storage array to comprise the (i)th data storage device disposed in two or more of said (N) data storage device assemblies, wherein (i) is greater than or equal to 1 and less than or equal to (M).

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing one embodiment of Applicants' data storage and retrieval system;

FIG. 2 is a block diagram showing the data storage and retrieval system of FIG. 1 comprising two initiators and a plurality of data storage devices;

FIG. 3A is a block diagram showing a plurality of data storage devices interconnected to a fibre channel arbitrated loop switch;

FIG. 3B is a block diagram showing the plurality of data storage devices of FIG. 3A comprising six data storage device assemblies;

FIG. 4 is a block diagram showing the six data storage device assemblies of FIG. 3B;

FIG. 5 is a block diagram showing three storage arrays, wherein those three storage arrays comprise the data storage device assemblies of FIG. 4;

FIG. 6 is a flow chart summarizing certain steps of Applicants' method.

### DETAILED DESCRIPTION OF THE PREFERRED EMBODIMENTS

This invention is described in preferred embodiments in the following description with reference to the Figures, in which like numbers represent the same or similar elements. The invention will be described as embodied in an information storage and retrieval system which comprises a plurality of data storage device assemblies, wherein each of those data storage device assemblies comprises a plurality of data storage devices.

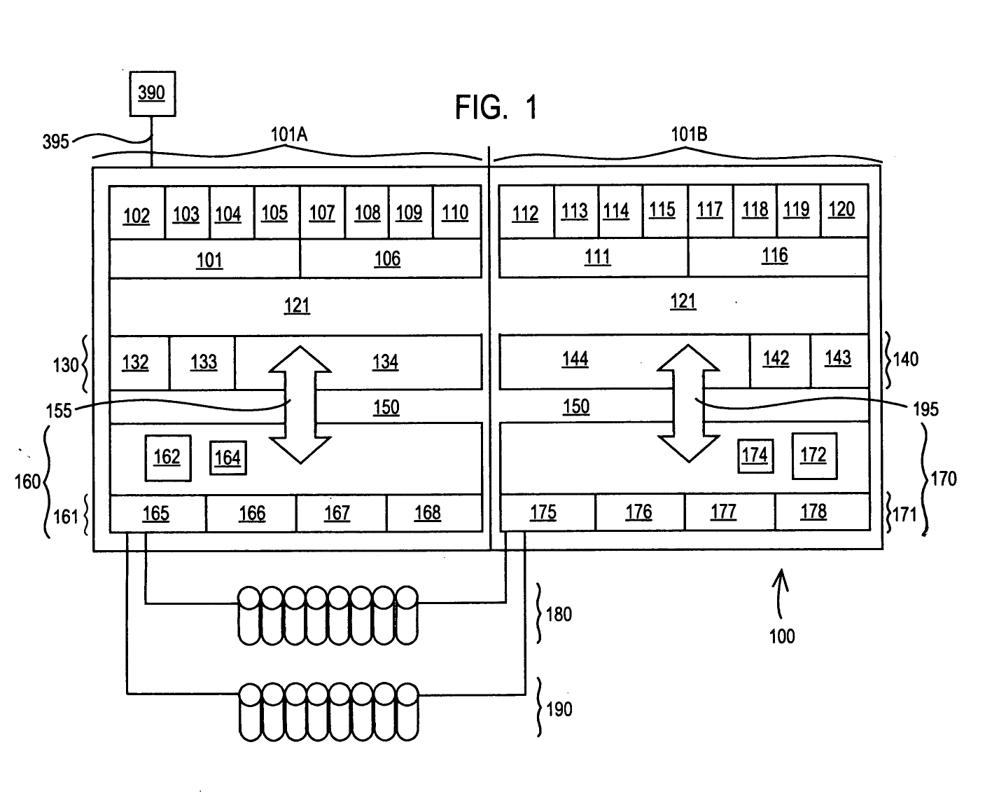

Referring now to FIG. 1, information storage and retrieval system 100 is capable of communication with host computer 390 via communication link 395. The illustrated embodiment of FIG. 1 shows a single host computer. In other embodiments, Applicants' information storage and retrieval system is capable of communicating with a plurality of host computers.

Host computer 390 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald). In certain embodiments, host computer 390 further includes a storage management program. The storage management program in the host computer 390 may include the functionality of storage management type programs known in the art that manage the transfer of data to and from a data storage and retrieval system, such as the IBM DFSMS implemented in the IBM MVS operating system.

In certain embodiments, Applicants' information storage and retrieval system includes a plurality of host adapters. In the illustrated embodiment of FIG. 1, system 100 comprises host adapters 102 - 105, 107 - 110, 112 - 115 and 117 - 120. In other embodiments, Applicants' information storage and retrieval system includes fewer than 16 host adapters. In still other embodiments, Applicants' information storage and retrieval system includes more than 16 host adapters. In certain embodiments, one or more of the host adapters are multi-ported. Regardless of the number of host adapters disposed in any embodiments of Applicants' system, each of those host adapters comprises a shared resource that has equal access to both central processing/cache elements 130 and 140.

Each host adapter may comprise one or more Fibre Channel ports, one or more FICON ports, one or more ESCON ports, or one or more SCSI ports, and the like. Each host adapter is connected to both clusters through interconnect bus 121 such that each cluster can handle I/O from any host adapter. Internal buses in each subsystem are connected via a Remote I/O bridge 155/195 between the processor portions 130/140 and I/O portions 160/170, respectively.

Processor portion 130 includes processor 132 and cache 134. In certain embodiments, processor portion 130 further includes memory 133. In certain embodiments, memory device 133 comprises random access memory. In certain embodiments, memory device 133 comprises non-volatile memory.

Processor portion 140 includes processor 142 and cache 144. In certain embodiments, processor portion 140 further includes memory 143. In certain embodiments, memory device 143 comprises random access memory. In certain embodiments, memory device 143 comprises non-volatile memory.

I/O portion 160 comprises a plurality of device adapters 161 which in the illustrated embodiment of FIG. 1 comprises device adapters 165, 166, 167, and 168. I/O portion 160 further comprise nonvolatile storage (“NVS”) 162 and battery backup 164 for NVS 162.

I/O portion 170 comprises a plurality of device adapters 171 which in the illustrated embodiment of FIG. 1 comprises device adapters 175, 176, 177, and 178. I/O portion 170 further comprises nonvolatile storage (“NVS”) 172 and battery backup 174 forNVS 172.

In certain embodiments of Applicants' system, one or more host adapters, processor portion 130, and one or more device adapters are disposed on a first control card disposed in Applicants' information storage and retrieval system. Similarly, in certain embodiments, one or more host adapters, processor portion 140, one or more device adapters are disposed on a second control card disposed in Applicants' information storage and retrieval system.

In the illustrated embodiment of FIG. 1, sixteen data storage devices are organized into two arrays, namely array 180 and array 190. The illustrated embodiment of FIG. 1 shows two storage device arrays.

In certain embodiments, one or more of the data storage devices comprise a plurality of hard disk drive units. In certain embodiments, arrays 180 and 190 utilize a RAID protocol. In certain embodiments, arrays 180 and 190 comprise what is sometimes called a JBOD array, i.e. “Just a Bunch Of Disks ” where the array is not configured according to RAID. In certain embodiments, arrays 180 and 190 comprise what is sometimes called an SBOD array, i.e. “Switched Bunch Of Disks ”.

The illustrated embodiment of FIG. 1 shows two storage device arrays. In other embodiments, Applicants' system includes a single storage device array. In yet other embodiments, Applicants' system includes more than two storage device arrays.

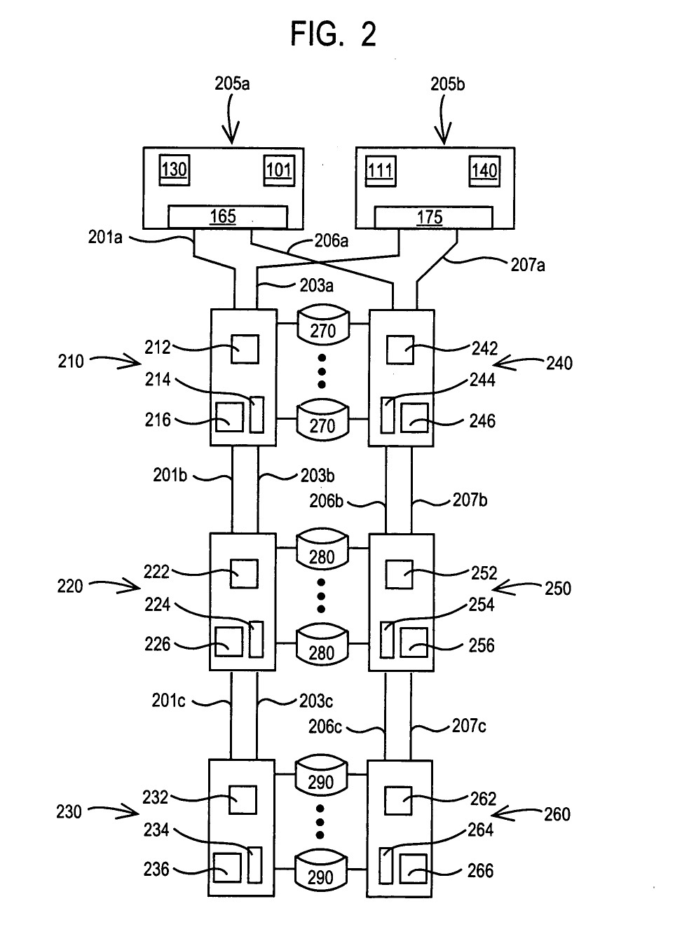

In the illustrated embodiment of FIG. 2, Applicants' information storage and retrieval system comprises dual fibre channel arbitrated (“FC-AL”) loops of switches where initiator 205a and initiator 205b are interconnected with two FC-AL loops. The illustrated embodiment of FIG. 2 should not be construed to limit Applicants' invention to use of fibre channel networks or devices. In the illustrated embodiment of FIG. 2, the recitation of two FC-AL loops comprises one embodiment of Applicants' apparatus. In other embodiments, other network topologies and devices are utilized, including without limitation SAS devices and/or SATA devices.

In the illustrated embodiment of FIG. 2, initiator 205a comprises plurality of host adapters 101 (FIGS. 1, 2), control element 130 (FIGS. 1, 2), and device adapter 165 (FIGs. 1, 2). In the illustrated embodiment of FIG. 2, initiator 205b comprises plurality of host adapters 111 (FIGS. 1, 2), control element 140 (FIGS. 1, 2), and device adapter 175 (FIGS. 1,2).

Each FC-AL loop contains one or more local controllers, such as local controllers 210, 220, 230, 240, 250, and 260. Each local controller comprises a switch, a processor, and microcode. In certain embodiments, the switch comprises a Fibre Channel switch. In certain embodiments, the processor comprises a SES processor. For example, local controllers 210, 220, 230, 240, 250, and 260, include processors 212, 222, 232, 242, 252, and 262, respectively. Similarly, local controllers 210, 220, 230, 240, 250, and 260, include switches 214, 224, 234, 244, 254, and 264, respectively. In addition, local controllers 210, 220, 230, 240, 250, and 260, include microcode 216, 226, 236, 246, 256, and 266, respectively.

Local controller 210 in combination with plurality of data storage devices 270 comprises a first switch domain. Local controller 240 in combination with plurality of storage devices 270 comprises a second switch domain.

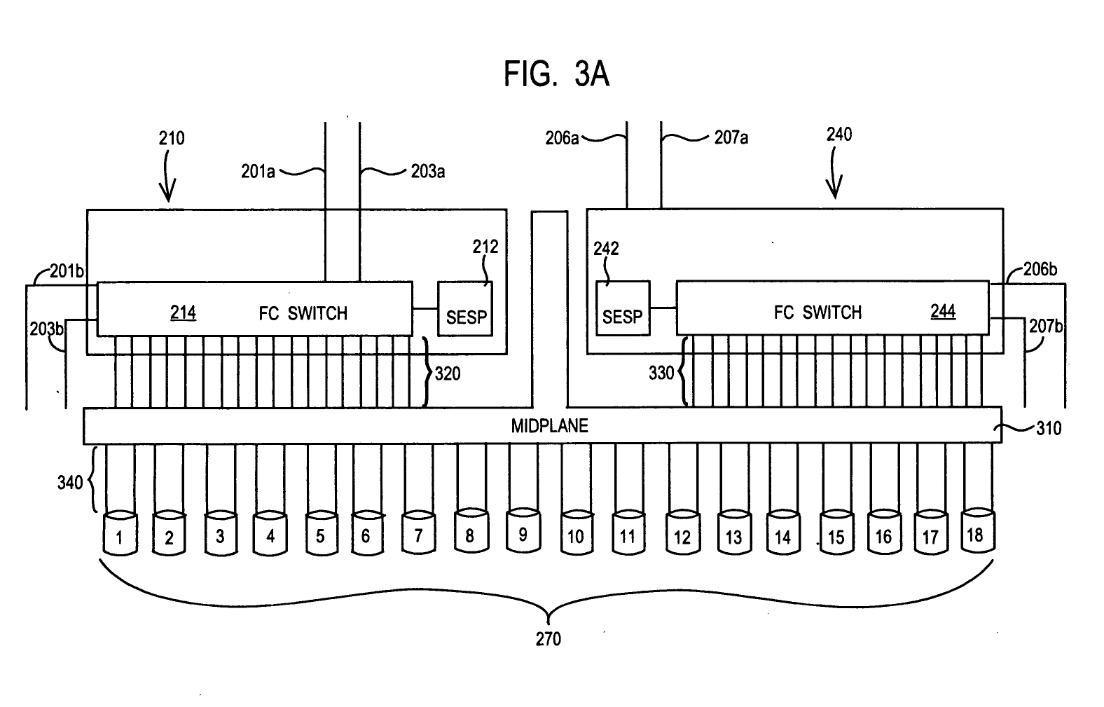

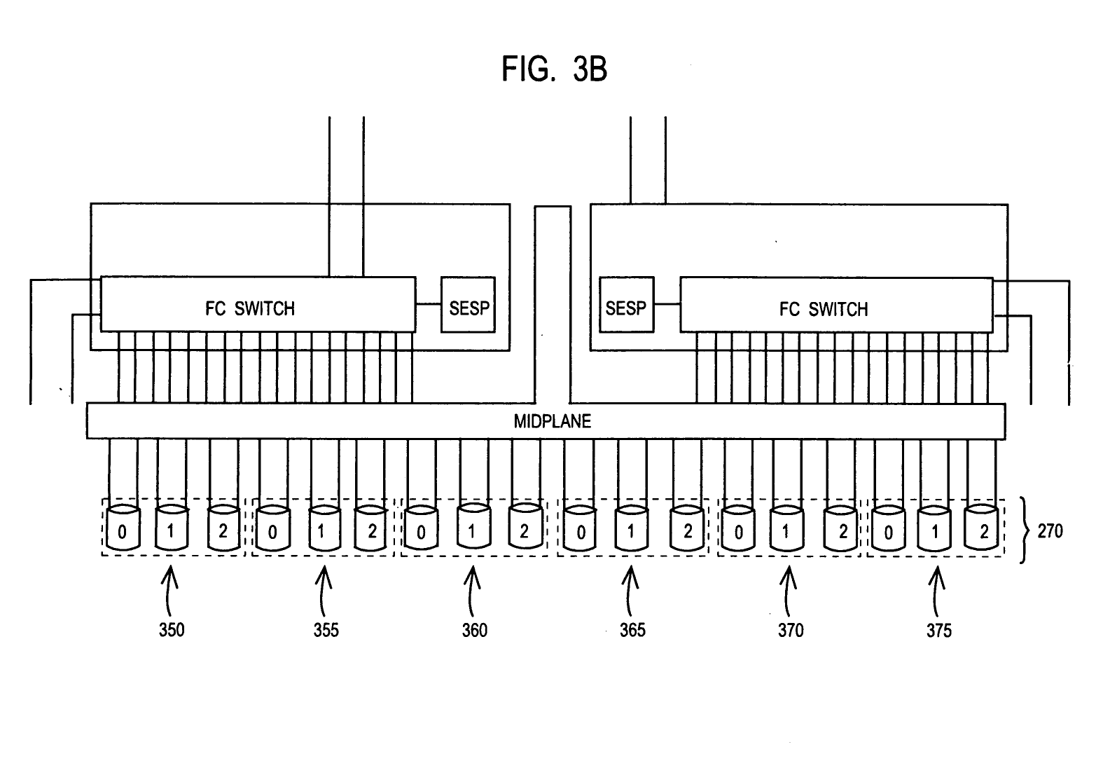

Referring now to FIG. 3A, in certain embodiments Applicants' apparatus further includes a midplane interconnecting one or more switches to one or more data storage devices. In the illustrated embodiment of FIG. 3A, controller 210 (FIGS. 2, 3) comprises Fibre Channel switch 214 (FIGS. 2, 3) and SES processor 212 (FIGS. 2, 3). A plurality of communication links 320 interconnect Fibre Channel switch 214 to midplane 310. A plurality of communication links 340 interconnect data storage devices 270 (FIGS. 2, 3) with midplane 310.

Controller 240 (FIGS. 2, 3) comprises Fibre Channel switch 244 (FIGS. 2, 3) and SES processor 242 (FIGS. 2, 3). A plurality of communication links 330 interconnect Fibre Channel switch 244 to midplane 310.

Signals are provided by switch 214 to data storage devices 270 via communication links 320, communication links 340, and midplane 310. Similarly, signals are provided by switch 244 to data storage devices 270 via communication links 330, communication links 340, and midplane 310.

In the illustrated embodiment of FIG. 3B, data storage devices 270 are disposed in six separate data storage device assemblies. Referring to FIGS. 3A and 3B, data storage devices 1, 2, and 3 of FIG. 3A comprise data storage device assembly 350 of FIG. 3B. Data storage devices 4, 5, and 6 of FIG. 3A comprise data storage device assembly 355 of FIG. 3B. Data storage devices 7, 8, and 9 of FIG. 3A comprise data storage device assembly 360 of FIG. 3B. Data storage devices 10, 11, and 12 of FIG. 3A comprise data storage device assembly 365 of FIG. 3B. Data storage devices 13, 14, and 15 of FIG. 3A comprise data storage device assembly 370 of FIG. 3B. Data storage devices 16, 17, and 18 of FIG. 3A comprise data storage device assembly 375 of FIG. 3B.

In certain embodiments, data storage device assemblies 350, 355, 360, 365, 370, and 375, comprise logical groupings of data storage devices. In certain embodiments, data storage device assemblies 350, 355, 360, 365, 370, and 375, comprise physical groupings of data storage devices, wherein each physical grouping comprises three data storage devices and the associated interconnections for those three data storage devices with midplane 310.

In certain embodiments, each such physical grouping of data storage devices comprises an integral assembly. In certain embodiments, each such physical grouping of data storage devices comprises a service boundary, wherein a repair or replacement of any one data storage device disposed in that assembly requires removal of the entire data storage device assembly from Applicants' data storage and retrieval system.

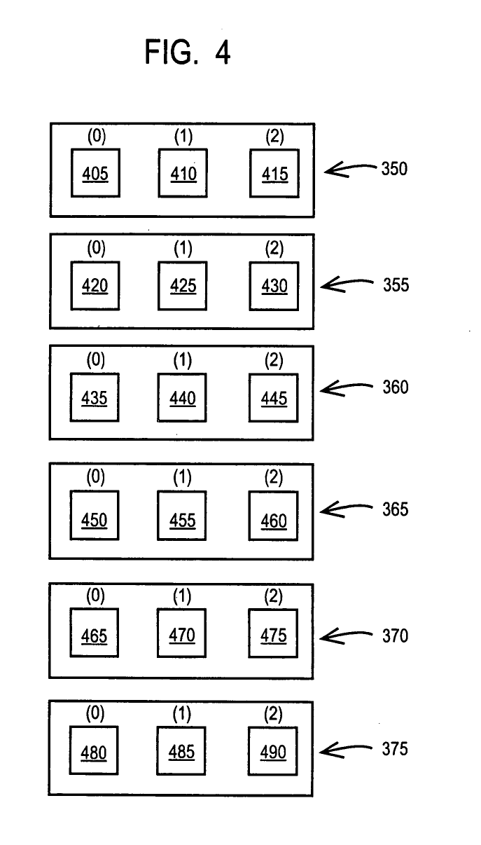

FIG. 4 shows the six data storage device assemblies of FIG. 3B. In the illustrated embodiment of FIG. 4, data storage device assembly 350 comprises data storage device 405, data storage device 410, and data storage device 415. Data storage device assembly 355 comprises data storage device 420, data storage device 425, and data storage device 430. Data storage device assembly 360 comprises data storage device 435, data storage device 440, and data storage device 445. Data storage device assembly 365 comprises data storage device 450, data storage device 455, and data storage device 460. Data storage device assembly 370 comprises data storage device 465, data storage device 470, and data storage device 475. Data storage device assembly 375 comprises data storage device 480, data storage device 485, and data storage device 490.

As those skilled in the art will appreciate, various storage protocols are known, such as for example various RAID protocols, wherein individual data storage devices are configured to comprise a storage array, and wherein data is saved to two or more data storage devices disposed in such a storage array using known RAID protocols.

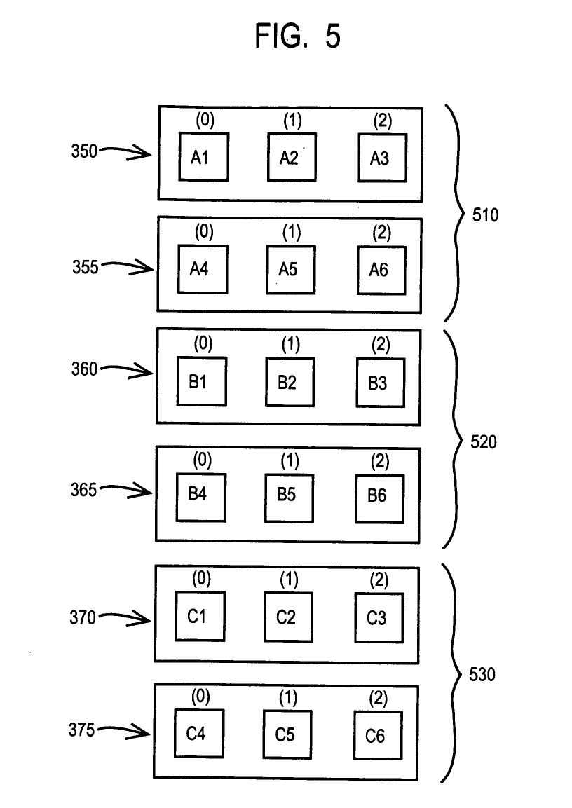

In the illustrated embodiment of FIG. 5, plurality of data storage devices 270, are disposed in six assemblies 350, 355, 360, 365, 370, and 375, wherein a first storage array 510 is configured to include the data storage devices disposed in data storage device assemblies 350 and 355. The illustrated embodiment of FIG. 5 further shows a second storage array 520 configured to comprise the data storage devices disposed in data storage device assemblies 360 and 365. The illustrated embodiment of FIG. 5 further shows a third storage array 530 configured to comprise the data storage devices disposed in data storage device assemblies 370 and 375.

In embodiments wherein each physical grouping of data storage devices, i.e. each data storage device assembly, comprises a service boundary, the repair or replacement of any one data storage device disposed in that assembly requires removal of the entire data storage device assembly from Applicants' data storage and retrieval system. Referring now to FIGS. 4 and 5, in the event, for example, data storage device 420 fails, data storage device assembly 355 would have to be removed from the data storage and retrieval system for repair. Using the storage array configurations of FIG. 5, removal of data storage device assembly 355 removes data storage devices 420, 425, and 430. Depending on the storage protocol being used, the removal of data storage devices 420, 425, and 430, from storage array 510 might result in rendering the storage array in an unusable state and/or an inability to rebuild the data stored on the remaining data storage devices comprising storage array 510.

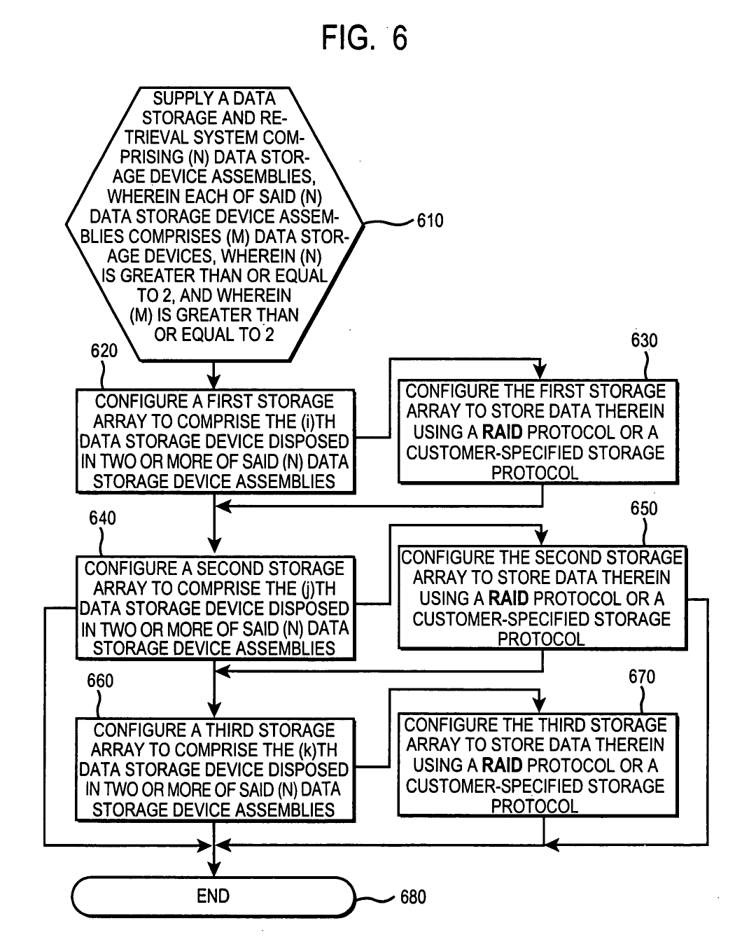

Applicants' invention comprises a method to configure one or more storage arrays in a data storage and retrieval system comprising (N) data storage device assemblies, wherein each of said (N) data storage device assemblies comprises (M) data storage devices, wherein (N) is greater than or equal to 2, and wherein (M) is greater than or equal to 2. FIG. 6 summarizes the steps of Applicants' methodReferring now to FIG. 6, in step 610 Applicants' method provides a data storage and retrieval system comprising (N) data storage device assemblies, wherein each of those (N) data storage device assemblies comprises (M) data storage devices. In certain embodiments, (M) is 2. In certain embodiments, (M) is 3. In certain embodiments, (M) is greater than 3.

In step 620, Applicants' method configures a first storage array to comprise the (i)th data storage device disposed in each of the (N) data storage device assemblies, wherein (i) is greater than or equal to 1 and less than or equal to (M). By the “(i)th data storage device,” Applicants mean a first one of the data storage devices disposed in each of the (N) data storage device assemblies without regard to the physical location of the data storage device in the data storage device assembly.

In certain embodiments, step 620 is performed by a processor, such as processor 132 (FIG. 1), disposed in the data storage and retrieval system. In certain embodiments, step 620 is performed by an initiator, such as initiator 205a (FIG. 2), disposed in the data storage and retrieval system. In certain embodiments, step 620 is performed by a host computer in communication with Applicants' data storage and retrieval system. In certain embodiments, Applicants' method transitions from step 620 to step 640.

The following example is presented to further illustrate to persons skilled in the art how to make and use the invention. This example is not intended as a limitation, however, upon the scope of the invention, which is defined only by the appended claims.

### EXAMPLE I

As an example and referring now to FIGS. 4 and 6, in step 620 a first storage array is configured to comprise data storage devices 405 and 430, wherein those data storage devices are disposed in data storage device assemblies 350 and 355, respectively. In the event, for example, data storage device 430 fails, data storage device assembly 355 would have to be removed from the data storage and retrieval system for repair. Removal of data storage device assembly 355 removes data storage devices 420, 425, and 430, wherein only device 430 is configured in the first storage array. The removal of data storage device 430 from the first storage array will not impact the availability of that first storage array, and is unlikely to result in an inability to rebuild the data stored on the remaining data storage devices comprising that first storage array.

In certain embodiments Applicants' method transitions from step 620 to step 640. In other embodiments, Applicants' method transitions from step 620 to step 630 wherein the first storage array of step 620 is configured to utilize a RAID protocol. In certain embodiments of Applicants' method, data storage and retrieval system is owned and/or operated by a data storage services provider, wherein that provider offers data storage services to one or more data storage services customers.

In certain embodiments, Applicants' first storage of step 620 is configured in step 630 to utilize a data storage protocol specified by a data storage services customer. In these embodiments, step 630 further comprises receiving customer data from a host computer owned and/or operated by one or more data storage services customers, and writing that customer data to Applicants' first storage array. Applicants' method transitions from step 630 to step 640.

In step 640, Applicants' method configures a second storage array to comprise the j)th data storage device disposed in two or more of the (N) data storage device assemblies, wherein (j) is greater than or equal to 1 and less than or equal to (M), and wherein (j) does not equal (i). By the “(j)th data storage device,” Applicants mean a second data storage device disposed in each of the (N) data storage device assemblies, without regard to the physical location of the data storage device in the data storage device assembly.

In certain embodiments, step 640 is performed by a processor, such as processor 132 (FIG. 1) disposed in the data storage and retrieval system. In certain embodiments, step 940 is performed by an initiator, such as initiator 205a (FIG. 2), disposed in the data storage and retrieval system. In certain embodiments, step 640 is performed by a host computer in communication with Applicants' data storage and retrieval system.

The following example is presented to further illustrate to persons skilled in the art how to make and use the invention. This example is not intended as a limitation, however, upon the scope of the invention, which is defined only by the appended claims.

### EXAMPLE II

For example and referring now to FIGS. 4 and 6, in step 640 a second storage array is configured to comprise data storage devices 415, 425, 455, 475, and 490, wherein those data storage devices are disposed in data storage device assemblies 350, 355, 365, 370, and 375, respectively. In the event, for example, data storage device 455 fails, data storage device assembly 365 would have to be removed from the data storage and retrieval system for repair. Removal of data storage device assembly 365 removes data storage devices 450, 455, and 460, wherein only device 455 is configured in the second storage array. The removal of data storage device 455 from the second storage array will not impact the availability of that storage array, and is unlikely to result in an inability to rebuild the data stored on the remaining data storage devices comprising the second storage array.

In certain embodiments, Applicants' method transitions from step 640 to step 680 and ends. In other embodiments, Applicants' method transitions from step 640 to step 660. In other embodiments, Applicants' method transitions from step 640 to step 650 wherein the second storage array of step 640 is configured to utilize a RAID protocol.

In certain embodiments, the second storage array of step 640 is configured in step 650 to utilize a data storage protocol specified by a data storage services customer. In these embodiments, step 650 further comprises receiving customer data from a host computer owned and/or operated by one or more data storage services customers, and writing that customer to Applicants' second storage array. In certain embodiments wherein (M) is 2, Applicants' method transitions from step 650 to step 680 and ends. In other embodiments, Applicants' method transitions from step 650 to step 660.

In certain embodiments, Applicants' data storage device assembly comprises three or more data storage devices, i.e. (M) is greater than or equal to 3. In certain embodiments, wherein (M) is greater than or equal to 3, Applicants' method includes steps 660 and optionally step 670. In step 660, Applicants' method configures a third storage array to comprise the (k)th data storage device disposed in two or more of said (N) data storage device assemblies, wherein (k) is greater than or equal to 1 and less than or equal to (M), and wherein (k) does not equal either (i) or (j). By the “(k)th data storage device,” Applicants mean a third data storage device disposed in each of the (N) data storage device assemblies, without regard to the physical location of the data storage device in the data storage device assembly.

In certain embodiments, step 660 is performed by a processor, such as processor 132 (FIG. 1) disposed in the data storage and retrieval system. In certain embodiments, step 960 is performed by an initiator, such as initiator 205a (FIG. 2), disposed in the data storage and retrieval system. In certain embodiments, step 660 is performed by a host computer in communication with Applicants' data storage and retrieval system.

The following example is presented to further illustrate to persons skilled in the art how to make and use the invention. This example is not intended as a limitation, however, upon the scope of the invention, which is defined only by the appended claims.

### EXAMPLE III

For example and referring now to FIGS. 4 and 6, in step 660 a third storage array is configured to comprise data storage devices 410, 420, 445, 450, 470, and 480, wherein those data storage devices are disposed in data storage device assemblies 350, 355, 360, 365, 370, and 375, respectively. In the event, for example, data storage device 480 fails, data storage device assembly 375 would have to be removed from the data storage and retrieval system for repair. Removal of data storage device assembly 375 removes data storage devices 480, 485, and 490, wherein only device 480 is configured in the third storage array. The removal of data storage device 480 from the third storage array will not impact the availability of that third storage array, and is unlikely to result in an inability to rebuild the data stored on the remaining data storage devices comprising the third storage array.

In certain embodiments, Applicants' method transitions from step 660 to step 680, and ends. In other embodiments, Applicants' method transitions from step 660 to step 670 wherein the third storage array of step 660 is configured in step 670 to utilize a RAID protocol. In certain embodiments, the third storage array of step 660 is configured in step 670 to utilize a data storage protocol specified by a data storage services customer. In these embodiments, step 670 further comprises receiving customer data from a host computer owned and/or operated by one or more data storage services customers, and writing that customer to Applicants' first storage array. Applicants' method transitions from step 670 to step 680 and ends.

In certain embodiments, individual steps recited in FIG. 6, may be combined, eliminated, or reordered.

In certain embodiments, Applicants' invention includes instructions residing in memory disposed in central processing/cache elements 130 (FIGS. 1, 2) and 140 (FIGS. 1, 2), where those instructions are executed by a processor, such as processor 132 (FIG. 1) and/or 142 (FIG. 1), respectively, to perform one or more of steps 620, 630, 640, 650, 660, and/or 670, recited in FIG. 6.

In other embodiments, Applicants' invention includes instructions residing in any other computer program product, where those instructions are executed by a computer external to, or internal to, system 100, to perform one or more of steps 620, 630, 640, 650, 660, and/or 670, recited in FIG. 6. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to configure one or more storage arrays in a data storage and retrieval system, comprising the steps of:
supplying a data storage and retrieval system comprising (N) data storage device assemblies, wherein each of said (N) data storage device assemblies comprises (M) data storage devices, wherein (N) is greater than or equal to 2, and wherein (M) is greater than or equal to 2;
configuring a first storage array to comprise the (i)th data storage device disposed in two or more of said (N) data storage device assemblies, wherein (i) is greater than or equal to 1 and less than or equal to (M).

2. The method of claim 1, further comprising the step of configuring said first storage array using a RAID protocol.

3. The method of claim 1, further comprising the step of configuring a second storage array to comprise the (j)th data storage device disposed in two or more of said (N) data storage device assemblies, wherein (j) is greater than or equal to 1 and less than or equal to (M), and wherein (j) does not equal (i).

4. The method of claim 3, further comprising the step of configuring said second storage array using a RAID protocol.

5. The method of claim 3, wherein (M) is greater than or equal to 3, further comprising the step of configuring a third storage array to comprise the (k)th data storage device disposed in two or more of said (N) data storage device assemblies, wherein (k) is greater than or equal to 1 and less than or equal to (M), and wherein (k) does not equal either (i) or (j).

6. The method of claim 5, further comprising the step of configuring said third storage array using a RAID protocol.

7. The method of claim 1, wherein said supplying step further comprises supplying a data storage and retrieval system comprising:
an SES processor interconnected with each of said (N) data storage device assemblies; and
an initiator interconnected with said SES processor;
wherein said configuring step is performed by said initiator.

8. An article of manufacture comprising a computer useable medium having computer readable program code disposed therein to configure one or more storage arrays in a data storage and retrieval system comprising (N) data storage device assemblies, wherein each of said (N) data storage device assemblies comprises (M) data storage devices, wherein (N) is greater than or equal to 2, and wherein (M) is greater than or equal to 2, the computer readable program code comprising a series of computer readable program steps to effect configuring a first storage array to comprise the (i)th data storage device disposed in two or more of said (N) data storage device assemblies, wherein (i) is greater than or equal to 1 and less than or equal to (M).

9. The article of manufacture of claim 8, said computer readable program code further comprising a series of computer readable program steps to effect configuring said first storage array using a RAID protocol.

10. The article of manufacture of claim 8, said computer readable program code further comprising a series of computer readable program steps to effect configuring a second storage array to comprise the (j)th data storage device disposed in two or more of said (N) data storage device assemblies, wherein (j) is greater than or equal to 1 and less than or equal to (M), and wherein (j) does not equal (i).

11. The article of manufacture of claim 10, said computer readable program code further comprising a series of computer readable program steps to effect configuring said second storage array using a RAID protocol.

12. The article of manufacture of claim 10, wherein (M) is greater than or equal to 3, said computer readable program code further comprising a series of computer readable program steps to effect configuring a third storage array to comprise the (k)th data storage device disposed in two or more of said (N) data storage device assemblies, wherein (k) is greater than or equal to 1 and less than or equal to (M), and wherein (k) does not equal either (i) or (j).

13. The article of manufacture of claim 12, said computer readable program code further comprising a series of computer readable program steps to effect configuring said third storage array using a RAID protocol.

14. A computer program product usable with a programmable computer processor having computer readable program code embodied therein to configure one or more storage arrays in a data storage and retrieval system comprising (N) data storage device assemblies, wherein each of said (N) data storage device assemblies comprises (M) data storage devices, wherein (N) is greater than or equal to 2, and wherein (M) is greater than or equal to 2, comprising:
computer readable program code which causes said programmable computer processor to configure a first storage array to comprise the (i)th data storage device disposed in two or more of said (N) data storage device assemblies, wherein (i) is greater than or equal to 1 and less than or equal to (M).

15. The computer program product of claim 14, further comprising computer readable program code which causes said programmable computer processor to configure said first storage array using a RAID protocol.

16. The computer program product of claim 14, further comprising computer readable program code which causes said programmable computer processor to configure a second storage array to comprise the (j)th data storage device disposed in two or more of said (N) data storage device assemblies, wherein (j) is greater than or equal to 1 and less than or equal to (M), and wherein (j) does not equal (i).

17. The computer program product of claim 16, further comprising computer readable program code which causes said programmable computer processor to configuring said second storage array using a RAID protocol.

18. The computer program product of claim 16, wherein (M) is greater than or equal to 3, further comprising computer readable program code which causes said programmable computer processor to configure a third storage array to comprise the (k)th data storage device disposed in two or more of said (N) data storage device assemblies, wherein (k) is greater than or equal to 1 and less than or equal to (M), and wherein (k) does not equal either (i) or (j).

19. The computer program product of claim 18, further comprising computer readable program code which causes said programmable computer processor to configure said third storage array using a RAID protocol.

20. A method to provide data storage services to one or more data storage services customers, comprising the steps of:
supplying a data storage and retrieval system comprising (N) data storage device assemblies, wherein each of said (N) data storage device assemblies comprises (M) data storage devices, wherein (N) is greater than or.equal to 2, and wherein (M) is greater than or equal to 2;
configuring a first storage array to comprise the (i)th data storage device disposed in two or more of said (N) data storage device assemblies, wherein (i) is greater than or equal to 1 and less than or equal to (M);
receiving data from said one or more customers; and
writing said customer data to said first storage array.
